(19) United States
(12) Patent Application Publication
(10) Pub. No.: US 2014/0056430 A1
(43) Pub. Date: Feb. 27, 2014

(54) SYSTEM AND METHOD FOR REPRODUCING WAVE FIELD USING SOUND BAR

(71) Applicant: Electronics and Telecommunications Research Institute, Daejeon (KR)

(72) Inventors: Keun Woo CHOI, Seoul (KR); Tae Jin PARK, Seoul (KR); Jeong Il SEO, Daejeon (KR); Jae Hyoun YOO, Daejeon (KR); Kyeong Ok KANG, Daejeon (KR)

(73) Assignee: Electronics and Telecommunications Research Institute, Daejeon (KR)

(21) Appl. No.: 13/970,741

(22) Filed: Aug. 20, 2013

(30) Foreign Application Priority Data
Aug. 21, 2012 (KR) 10-2012-0091357
Apr. 17, 2013 (KR) 10-2013-0042221

(51) Int. Cl. H04S 5/00

(52) U.S. Cl. CPC H04S 5/00
USPC 381/17

(57) ABSTRACT

Disclosed is a system and method for reproducing a wave field that reproduces a wave field using a sound bar, the system including an input signal analyzer to divide an input signal into an audio signal for a plurality of channels, and identify a position of a loud speaker corresponding to the plurality of channels, a rendering unit to process the audio signal for the plurality of channels, using a rendering algorithm based on the position, and generate an output signal, and a loud speaker array to output the output signal using loud speakers corresponding to the plurality of channels, and reproduce a wave field.

### CROSS-REFERENCE TO RELATED APPLICATIONS

This application claims the priority benefit of Korean Patent Application No. 10-2012-0091357, filed on Aug. 21, 2012, and Korean Patent Application No. 10-2013-0042221, filed on Apr. 17, 2013, in the Korean Intellectual Property Office, the disclosures of which are incorporated herein by reference.

### BACKGROUND

1. Field of the Invention

The present invention relates to a system and method for reproducing a wave field using a sound bar, and more particularly, to a system and method for reproducing a wave field through outputting an audio signal processed using differing rendering algorithms, using a sound bar.

2. Description of the Related Art

Sound reproduction technology may refer to technology for reproducing a wave field for detecting a position of a sound source, through outputting an audio signal, using a plurality of speakers. Also, a sound bar may be a new form of a loud speaker configuration, and refer to a loud speaker array in which a plurality of loud speakers is connected.

Technology for reproducing a wave field, using a forward speaker array, such as a sound bar, is disclosed in Korean Patent Publication No. 10-2009-0110598, published on 22 Oct. 2009.

In a conventional art, a wave field may be reproduced through determining a signal to be radiated in an arc array form, based on wave field playback information, however, a limit lies therein in terms of reproducing a sound source disposed at a rear or at a side.

Accordingly, there is a need for a method for reproducing a wave field without a side speaker or a rear speaker.

### SUMMARY

An aspect of the present invention provides a system and method for reproducing a wave field using a sound bar without disposing an additional loud speaker at a side or at a rear, through forming a virtual wave field similar to an original wave field in a forward channel, using a wave field rendering algorithm, and disposing a virtual sound source in a listening space for a side channel and a rear channel for a user to sense a stereophonic sound effect.

According to an aspect of the present invention, there is provided a system for reproducing a wave field, the system including an input signal analyzer to divide an input signal into an audio signal for a plurality of channels, and identify a position of a loud speaker corresponding to the plurality of channels, a rendering unit to process the audio signal for the plurality of channels, using a rendering algorithm based on the position, and generate an output signal, and a loud speaker array to output the output signal via the loud speaker corresponding to the plurality of channels, and reproduce a wave field.

The rendering unit may process an audio signal for a plurality of channels corresponding to a forward channel, using a wave field synthesis rendering algorithm, and process an audio signal for a plurality of channels corresponding to a side channel or a rear channel.

The rendering unit may determine a position at which a focused sound source is to be generated based on a listening space in which a wave field is reproduced when an audio signal for a plurality of channels is processed, using a focused sound source rendering algorithm.

The rendering unit may select, from among a focused sound source rendering algorithm, a beam-forming rendering algorithm, and a deccorelator rendering algorithm, based on a characteristic of a sound source, and process an audio signal for a plurality of channels, using the selected algorithm.

According to an aspect of the present invention, there is provided an apparatus for reproducing a wave field, the apparatus including a rendering selection unit to select a rendering algorithm for a plurality of channels, based on at least one of information associated with a listening space in which a wave field is to be reproduced, a position of a channel, and a characteristic of a sound source, and a rendering unit to render an audio signal of a channel, using the selected rendering algorithm.

The rendering unit for rendering the audio signal may select a wave field synthesis rendering algorithm when the channel is a forward channel disposed in front of a user, or a position of a sound source is disposed at a rear of a speaker for outputting the audio signal.

The rendering selection unit may select a focused sound source rendering algorithm when the channel is a side channel disposed at a side of a user, and a rear channel disposed behind the user.

The rendering unit for rendering the audio signal may perform rendering on audio signals output from a speaker to be gathered at a predetermined position simultaneously, and generate a focused sound source at the predetermined position.

The rendering unit for rendering the audio signal may render the audio signal to generate a focused sound source at a position adjacent to a wall when a wall is present at a side and a rear of a listening space in which a wave field is to be reproduced.

The rendering unit for rendering the audio signal may render the audio signal to generate a focused sound source at a position adjacent to a user when a wall is absent at a side and a rear of a listening space in which a wave field is to be reproduced.

The rendering selection unit may select a beam-forming rendering algorithm when a sound source has a directivity, or a surround sound effect.

The rendering selection unit may select a decorrelator rendering algorithm in a presence of an effect of a sound source to be reproduced in a wide space.

According to an aspect of the present invention, there is provided a method for reproducing a wave field, the method including dividing an input signal into an audio signal for a plurality of channels, and identifying a position of a loud speaker corresponding to the plurality of channels, processing the audio signal for the plurality of channels, using a rendering algorithm based on the position, and generating an output signal, and outputting the output signal, using the loud speaker corresponding to the plurality of channels, and reproducing a wave field.

According to an aspect of the present invention, there is provided a method for reproducing a wave field, the method including selecting a rendering algorithm for a plurality of channels, based on at least one of information associated with a listening space in which a wave field is reproduced, a position of a channel, and a characteristic of a sound source, and rendering an audio signal of a channel, using the selected rendering algorithm.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 is a diagram illustrating a system for reproducing a wave field according to an embodiment of the present invention;

FIG. 2 is a diagram illustrating an operation of a system for reproducing a wave field according to an embodiment of the present invention;

FIG. 3 is a diagram illustrating an input signal processor according to an embodiment of the present invention;

FIG. 4 is a diagram illustrating an operation of an input signal processor according to an embodiment of the present invention;

FIG. 5 is a diagram illustrating a renderer according to an embodiment of the present invention;

FIG. 6 is a diagram illustrating an operation of a renderer according to an embodiment of the present invention;

FIG. 7 is a diagram illustrating an example of a wave field reproduced by a system for reproducing a wave field according to an embodiment of the present invention;

FIG. 8 is a diagram illustrating another example of a wave field reproduced by a system for reproducing a wave field according to an embodiment of the present invention;

FIG. 9 is a diagram illustrating a method for reproducing a wave field according to an embodiment of the present invention; and

FIG. 10 is a flowchart illustrating a method for selecting rendering according to an embodiment of the present invention.

### DETAILED DESCRIPTION

Reference will now be made in detail to exemplary embodiments of the present invention, examples of which are illustrated in the accompanying drawings, wherein like reference numerals refer to the like elements throughout. Exemplary embodiments are described below to explain the present invention by referring to the figures.

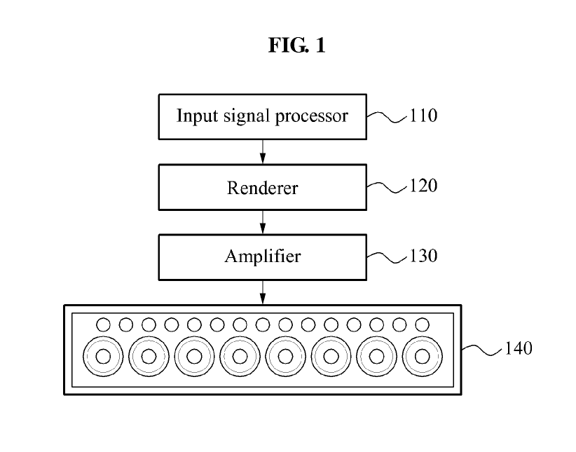

FIG. 1 is a diagram illustrating a system for reproducing a wave field according to an embodiment of the present invention.

Referring to FIG. 1, the system for reproducing the wave field may include an input signal processor 110, a renderer 120, an amplifier 130, and a loud speaker array 140.

The input signal processor 110 may analyze an input signal into an audio signal for a plurality of channels, and identify a position of a loud speaker corresponding to the audio signal for the plurality of channels.

Here, the input signal may include at least one of an analog audio input signal, a digital audio input signal, and an encoded audio bitstream. Also, the input signal processor 110 may receive an input signal from an apparatus, such as, a digital versatile disc (DVD), a Blu-ray disc (BD), a Moving Picture Experts Group-1 (MPEG-1) or MPEG-2 Audio Layer III (MP3) player.

The position of the loud speaker identified by the input signal processor 110 may refer to a position of a loud speaker in a virtual space. Here, the position of the loud speaker in the virtual space may refer to a position of a virtual sound source at which a user is enabled to sense whether the loud speaker is disposed at a corresponding position when the system for reproducing the wave field reproduces a wave field.

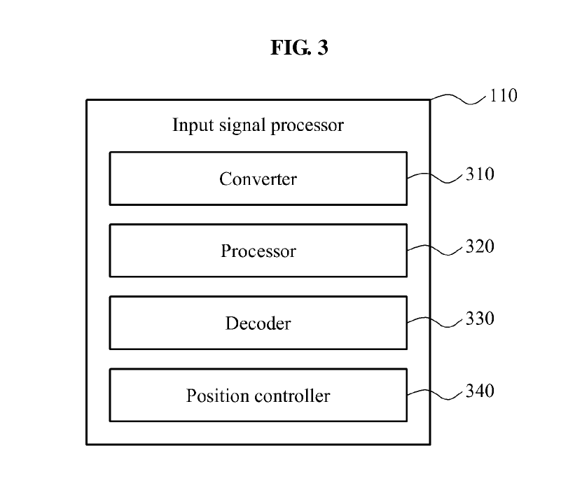

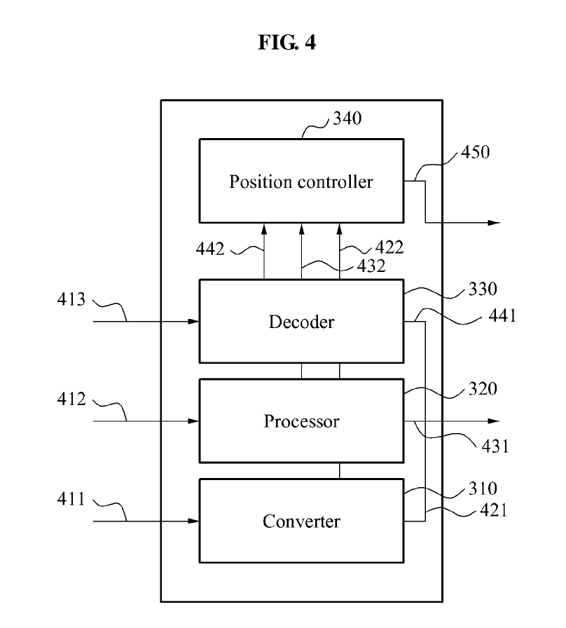

A detailed configuration and an operation of the input signal processor 110 will be discussed in detail with reference to FIGS. 3 and 4.

The renderer 120 may select a rendering algorithm, based on a position of a loud speaker corresponding to a channel, and generate an output signal through processing an audio signal for a plurality of channels, using the selected rendering algorithm. The renderer 120 may select rendering algorithms differing based on the plurality of channels, and process the audio signal for the plurality of corresponding channels, using the selected rendering algorithm since the position of the loud speaker differs based on the plurality of channels.

Here, the renderer 120 may receive an input of information selected by a user, and select a rendering algorithm for processing an audio signal for a plurality of channels.

Also, the renderer 120 may determine an optimal position at which a virtual sound source is generated, using a microphone signal provided in a listening space.

Further, the renderer 120 may generate an output signal through processing the audio signal for the plurality of channels and position data of the loud speaker corresponding to the plurality of channels, using the determined position at which the virtual sound source is generated and the selected rendering algorithm.

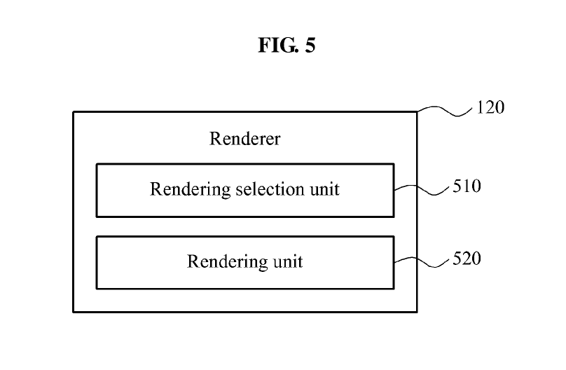

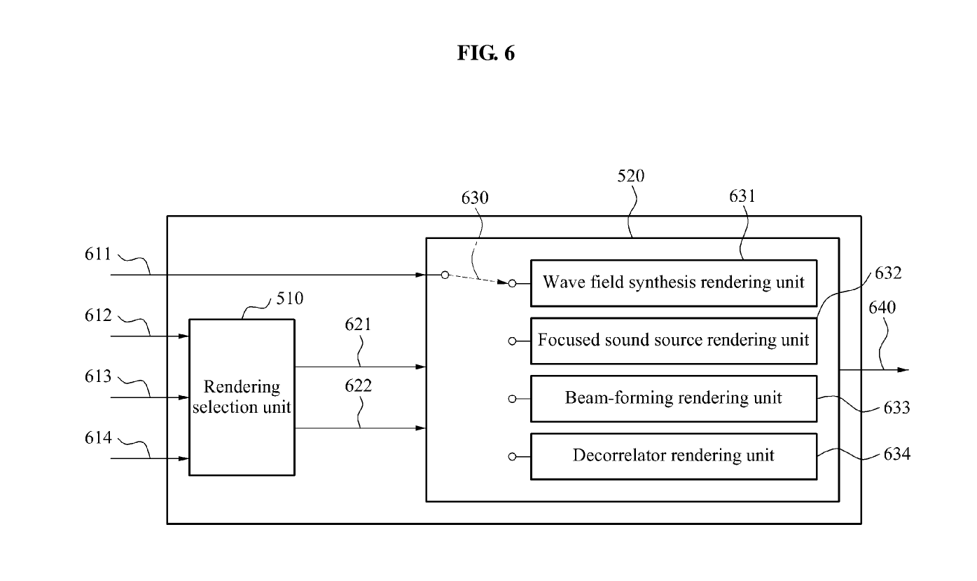

A detailed configuration and an operation of the renderer 120 will be discussed in detail with reference to FIGS. 5 and 6.

The amplifier 130 may amplify the output signal generated by the renderer 120, and output the output signal via the loud speaker array 140.

The loud speaker array 140 may reproduce a wave field through outputting the output signal amplified by the amplifier 130. Here, the loud speaker array 140 may refer to a sound bar created by connecting a plurality of loud speakers into a single sound bar.

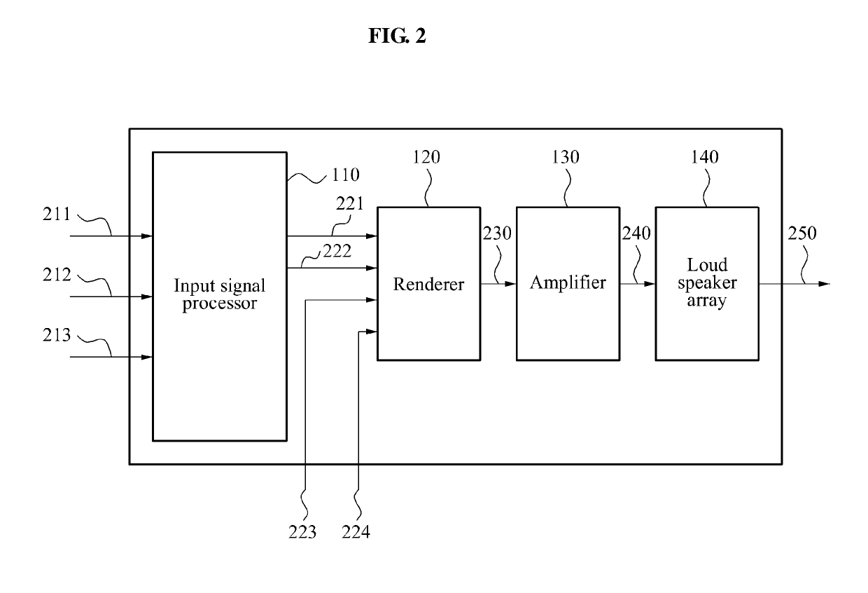

FIG. 2 is a diagram illustrating an operation of a system for reproducing a wave field according to an embodiment of the present invention.

The input signal processor 110 may receive an input signal of at least one of an analog audio input signal 211, a digital audio input signal 212, and an encoded audio bitstream 213.

The input signal processor 110 may divide an input signal into an audio signal 221 for a plurality of channels, and transmit the audio signal 221 for the plurality of channels to the renderer 120. Also, the input signal processor 110 may identify a position of a loud speaker corresponding to the audio signal 221 for the plurality of channels, and transmit position data 222 of the identified loud speaker to the renderer 120.

The renderer 120 may select a rendering algorithm based on the position data 222 of the loud speaker, and generate an output signal through processing the audio signal 221 for the plurality of channels, using the selected rendering algorithm. Here, the renderer 120 may select the rendering algorithm for processing the audio signal 221 for the plurality of channels, through receiving an input of information 223 selected by a user. Here, the renderer 120 may receive an input of the information 223 selected by the user, through a user interface signal.

Also, the renderer 120 may determine an optimal position at which a virtual sound source is generated, using a signal 224 received from a microphone provided in a listening space.

Here, the microphone may collect an output signal output from a loud speaker, and transmit the collected output signal to the renderer 120. For example, the microphone may convert the signal 224 collected by the microphone into an external calibration input signal, and transmit the external calibration input signal to the renderer 120.

The renderer 120 may process an audio signal for a plurality of channels and position data of the loud speaker corresponding to the plurality of channels, using the determined position at which the virtual sound source is generated and the rendering algorithm.

The amplifier 130 may amplify an output signal 230 generated by the renderer 120, and output the amplified output signal 230 via the loud speaker array 140.

The loud speaker array 140 may output the output signal 240 amplified by the amplifier 130, and reproduce a wave field 240.

FIG. 3 is a diagram illustrating an input signal processor according to an embodiment of the present invention.

Referring to FIG. 3, the input signal processor 110 may include a converter 310, a processor 320, a decoder 330, and a position controller 340.

The converter 310 may receive an analog audio input signal, and convert the received analog audio input signal into a digital signal. Here, the analog audio input signal may refer to a signal divided for a plurality of channels. For example, the converter 310 may refer to an analog/digital converter.

The processor 320 may receive a digital audio signal, and divide the received digital audio signal for the plurality of channels. Here, the digital audio signal received by the processor 320 may refer to a multi-channel audio signal, for example, a Sony/Philips digital interconnect format (SPDIF), a high definition multimedia interface (HDMI), a multi-channel audio digital interface (MADI), and an Alesis digital audio tape (ADAT). For example, the processor 320 may refer to a digital audio processor.

The decoder 330 may output an audio signal for a plurality of channels through receiving an encoded audio bitstream, and decoding the encoded audio bitstream received. Here, the encoded audio bitstream may refer to a compressed multi-channel signal, such as an audio code number 3 (AC-3). For example, the decoder 330 may refer to a bitstream decoder.

An optimal position of a loud speaker via which an audio signal for a plurality of channels is played may be determined for a multi-channel audio standard, for example, a 5.1 channel or a 7.1 channel.

Also, the decoder 330 may recognize information associated with an audio channel through decoding the audio bitstream.

The converter 310, the processor 320, and the decoder 330 may identify the position of the loud speaker corresponding to the audio signal for a plurality of channels converted, divided, and decoded based on the multi-channel audio standard, and transmit a position cue for representing the optimal position of the loud speaker via which the audio signal for the plurality of channels is played to the position controller 340.

The position controller 340 may convert the position cue received from one of the converter 310, the processor 320, and the decoder 330 into the position data in a form that may be be input to the renderer 120, and output the position data. For example, the position data may be in a form of (x, y), (r, θ), (x, y, z), or (r, θ, φ). Also, the position controller 340 may refer to a virtual loudspeaker position controller.

Further, the position controller 340 may convert the information associated with the audio channel recognized by the decoder 330 into the position cue to identify the position of the loud speaker, and convert the converted position cue into the position data to output the converted position data.

The position controller 340 may receive the position cue generated in a form of additional metadata, and convert the received position cue into the position data to output the converted position data.

FIG. 4 is a diagram illustrating an operation of an input signal processor according to an embodiment of the present invention.

The converter 310 may receive an analog audio input signal 411, and convert the received analog audio input signal 411 into a digital signal 421 to output the converted digital signal 421. Here, the analog audio input signal 411 may refer to a signal divided for a plurality of channels. Also, the converter 310 may identify a position of a loud speaker corresponding to the audio signal 421 for the plurality of channels converted based on the multi-channel audio standard, and transmit a position cue 422 for representing an optimal position of the loud speaker via which the audio signal 421 for the plurality of channels is played to the position controller 340.

The processor 320 may receive a digital audio signal 412, divide the received digital audio signal 412 into the plurality of channels, and output an audio signal 431 for the plurality of channels.

Here, the processor 320 may identify a position of a loud speaker corresponding to the audio signal 431 for the plurality of channels divided based on the multi-channel audio standard, and transmit a position cue 432 for representing the optimal position of the loud speaker via which the audio signal 431 for the plurality of channels is played to the position controller 340.

Also, the decoder 330 may receive the encoded audio bitstream 413, and decode the encoded audio bitstream 413 received to output an audio signal 441 for the plurality of channels. Here, the decoder 330 may identify the position of the loud speaker corresponding to the audio signal 441 for the plurality of channels, decoded based on the standards, and transmit a position cue 442 for representing an optimal position of the loud speaker via which the audio signal for the plurality of channels is played to the position controller 340.

Also, the decoder 330 may decode the encoded audio bitstream 413, and recognize information associated with an audio channel.

The position controller 340 may receive a position cue from one of the converter 310, the processor 320, and the decoder 330, and convert the received position cue into position data 450 in a form that may be input to the renderer 120 to output the position data 450. For example, the position data 450 may be in a form of (x, y), (r, θ), (x, y, z), or (r, θ, φ).

Also, the position controller 340 may identify the position of the loud speaker, using the position cue converted from the information associated with the audio channel recognized by the decoder 330, or the position cue included in the digital audio signal 412, and convert the converted position cue into the position data 450 to output the position data 450.

The position controller 340 may receive a position cue generated in a form of additional metadata, and convert the received position cue into the position data 450 to output the position data 450.

FIG. 5 is a diagram illustrating a renderer according to an embodiment of the present invention.

Referring to FIG. 5, the renderer 120 may include a rendering selection unit 510 and a rendering unit 520.

The rendering selection unit 510 may select a rendering algorithm to be applied to an audio signal for a plurality of channels, based on at least one of information associated with a listening space for reproducing a wave field, a position of a channel, and a characteristic of a sound source.

When a channel is a forward channel disposed in front of a user, or a position of the sound source is disposed behind a speaker for outputting the audio signal, the rendering selection unit 510 may select a wave field synthesis rendering algorithm to be a rendering algorithm to be applied to the audio signal for a plurality of channels.

When a channel is a side channel disposed at a side of a user, or a rear channel disposed behind the user, the rendering selection unit 510 may select a focused source rendering algorithm, or a beam-forming rendering algorithm to be the rendering algorithm to be applied to the audio signal for the plurality of channels.

Also, when the sound source has a directivity or a surround sound effect, the rendering selection unit 510 may select the focused sound source rendering algorithm, or the beam-forming rendering algorithm to be the rendering algorithm to be applied to the audio signal for the plurality of channels.

When an effect of reproducing a sound source in a wide space is present, or a width of the sound source is to be expanded, the rendering selection unit 510 may select a deccorelator rendering algorithm to be the rendering algorithm to be applied to the audio signal for the plurality of channels.

Also, the rendering selection unit 510 may select one of the rendering algorithms for the audio signal for the plurality of channels, based on information selected by the user.

The rendering unit 520 may render the audio signal for the plurality of channels, using the rendering algorithm selected by the rendering selection unit 510.

The rendering unit 520 may reproduce a virtual wave field similar to an original wave field through rendering the audio signal for the plurality of channels, using a wave field synthesis rendering algorithm when the rendering selection unit 510 selects the wave field synthesis rendering algorithm.

When the rendering selection unit 510 selects a focused sound source rendering algorithm, the rendering unit 520 may perform rendering on the audio signals to gather the audio signals output from the speaker at a predetermined position simultaneously, and generate a focused sound source at the predetermined position. Here, the focused sound source may refer to a virtual sound source.

Also, when the rendering selection unit 510 selects the focused sound source rendering algorithm, the rendering unit 520 may verify whether a wall is present at a side or at a rear of a listening space for reproducing a wave field. Here, the rendering selection unit 510 may verify whether the wall is present at the side or at the rear of the listening space for reproducing the wave field, based on a microphone signal provided in the listening space, or information input by the user.

When the wall is present at the side or the rear of the listening space, the rendering unit 520 may generate the focused sound source at a position adjacent to the wall through rendering the audio signal for the plurality of channels, using the focused sound source rendering algorithm, and a wavefront generated from the focused sound source is reflected off of the wall to be transmitted to the user.

Also, when the wall is absent at the side and the rear of the listening space, the rendering unit 520 may generate the focused sound source at a position adjacent to the user through rendering the audio signal for the plurality of channels, using the focused sound source rendering algorithm, and transmit the wavefront generated from the focused sound source directly to the user.

FIG. 6 is a diagram illustrating an operation of a renderer according to an embodiment of the present invention.

The rendering unit 520 may include a wave field synthesis rendering unit 631 for applying a rendering algorithm, a focused sound source rendering unit 632, a beam forming rendering unit 633, a decorrelator rendering unit 634, and a switch 630 for transferring an audio signal for a plurality of channels to one of the configurations above, as shown in FIG. 6.

The rendering selection unit 510 may receive at least one of virtual loud speaker position data 612, an input signal 613 of a user, and information 614 associated with a playback space, obtained using a microphone. Here, the input signal 613 of the user may include information associated with a rendering algorithm selected by the user manually, and the information 614 associated with the playback space may include information on whether a wall is present at a side or a rear of a listening space.

The rendering selection unit 510 may select a rendering algorithm to be applied to the audio signal for the plurality of channels, based on the information received, and transmit the selected rendering algorithm 621 to the renderer 520. Here, the renderer selection unit 510 may transmit position data 622 to the renderer 520. Here, the position data 622 transmitted by the rendering selection unit 510 may refer to information used in a rendering process. For example, the position data 622 may be on one of position data associated with general speakers when the general speakers are used rather than the loud speaker array 140, such as the virtual loud speaker position data 612, virtual sound source position data, and a sound bar.

More particularly, when the user selects information associated with the listening space, a desired position, and a rendering algorithm via a user interface, the rendering selection unit 510 may transmit the information selected by the user to the renderer 520. Also, when the input signal of the user is absent, the rendering selection unit 510 may select the rendering algorithm, using the virtual loud speaker position data 612.

The rendering selection unit 510 may receive an input of a wave field reproduced by the loud speaker array 140 via an external calibration input, and analyze the information associated with the listening space, using the wave field input.

The switch 630 may transmit the audio signal 611 for the plurality of channels to one of the wave field synthesis rendering unit 631, the focused sound source rendering unit 632, the beam forming rendering unit 633, and the decorrelator rendering unit 634, based on the rendering algorithm 621 selected by the rendering selection unit 510.

The wave field synthesis rendering unit 631, the focused sound source rendering unit 632, the beam forming rendering unit 633, and the decorrelator rendering unit 634 may use differing rendering algorithms, and apply post-processing schemes, aside from the rendering algorithm, for example, an audio equalizer, a dynamic range compressor, or the like, to the audio signal for the plurality of channels.

The wave field rendering unit 631 may render the audio signal, using the wave field synthesis rendering algorithm.

More particularly, the wave field synthesis rendering unit 631 may determine a weight and a delay to be applied to a plurality of loud speakers, based on a position and a type of a sound source.

The rendering selection unit 510 may select the wave field synthesis rendering algorithm when the position of the sound source is disposed outside of the listening space or the rear of the loud speaker, or the loud speaker corresponding to the plurality of channels is a forward channel disposed in front of the user, the rendering selection unit 510 may select the wave field synthesis rendering algorithm. Here, the switch 630 may transfer an audio signal for a plurality of forward channels, and an audio signal for the plurality of channels for reproducing a sound source disposed outside of the listening space to the wave field synthesis rendering unit 631.

The focused sound source rendering unit 632 may perform rendering on audio signals to gather the audio signals output from the speaker at a predetermined position simultaneously, using the focused sound source rendering algorithm, and generate a focused sound source at the predetermined position.

More particularly, the focused sound source rendering unit 632 may apply a time-reversal method for implementing a direction in which a sound wave progresses, in an inverse order to the audio signal for the plurality of channels, based on a time when a point sound source is implemented using the wave field synthesis algorithm. Here, when the audio signal for the plurality of channels to which the time-reversal method is applied is radiated from the loud speaker array 140, the audio signal for the plurality of channels may be focused at a single point simultaneously, and generate a focused sound source which allows a user to sense as if an actual sound source exists.

The focused sound source may be applied to an instance in which the position data 622 of the channel is inside the listening space because the focused sound source is a virtual sound source formed inside the listening space. For example, when a 5.1 channel and a 7.1 channel are rendered, the focused sound source may be applied to the audio signal for the plurality of channels, such as a side channel and a rear channel.

The focused sound source rendering unit 632 may determine different positions at which the focused sound is generated based on the listening space.

For example, when a reflection of a sound is available for use due to a presence of a wall at a side and a rear of the listening space, the focused sound source rendering unit 632 may generate a focused sound source adjacent to the wall, and a wavefront generated from the focused sound source may be reflected off the wall so as to be heard by the user.

When the wall is absent at the side and the rear of the listening space, or the reflection off the wall is unlikely due to a relatively large distance between the user and the wall, the focused sound source rendering unit 632 may generate the focused sound source adjacent to the user, and enable the user to listen to a corresponding sound source directly.

The beam forming rendering unit 633 may have a directivity in a predetermined direction when the audio signal for the plurality of channels is output from the loud speaker array 140 through applying the beam forming rendering algorithm to the audio signal for the plurality of channels. Here, the audio signal for the plurality of channels may be transmitted directly toward the listening space, or be reflected off the side or the rear of the listening space to create a surround sound effect.

The decorrelator rendering unit 634 may apply a decorrelator rendering algorithm to the audio signal for the plurality of channels, and reduce an inter-channel correlation (ICC) of a signal applied to the plurality of channels of the loud speaker. Here, the sound sensed by the user may be similar to a sound sensed in a wider space because an inter-aural correlation (IAC) of a signal input to both ears of the user decreases.

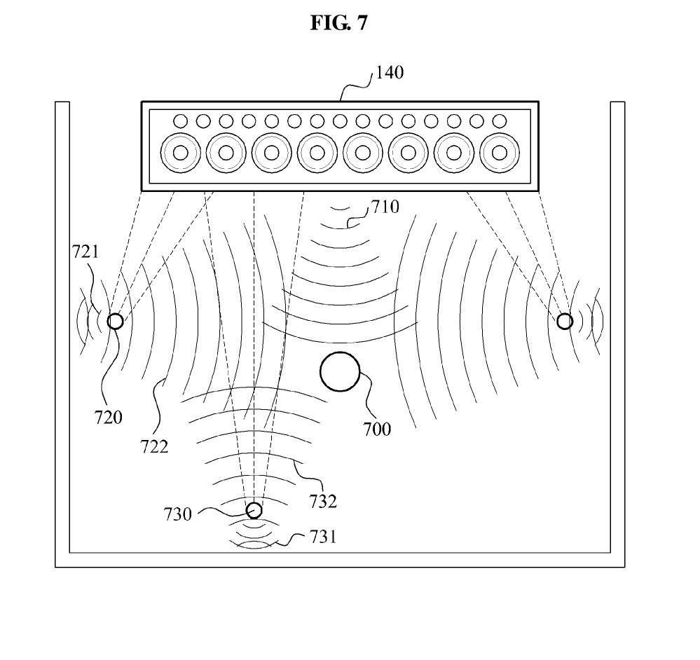

FIG. 7 is a diagram illustrating an example of a wave field reproduced by a system for reproducing a wave field according to an embodiment of the present invention.

In particular, FIG. 7 is an example in which the system for reproducing the wave field reproduces a wave field when a wall is present at a side and a rear of a listening space.

The renderer 120 of the system for reproducing the wave field may perform rendering on an audio signal for a plurality of forward channels, using a wave field synthesis rendering algorithm, and perform rendering on an audio signal for a plurality of side channels and rear channels, using a focused sound source rendering algorithm.

The loud array speaker 140 may output the audio signal for the plurality of channels rendered by the renderer 120.

Here, a loud speaker corresponding to a forward channel in the loud array speaker 140 may output the audio signal for the plurality of channels rendered using the wave field synthesis rendering algorithm, and reproduce a virtual wave field 710 similar to an original wave field in front of a user 700.

Also, a loud speaker corresponding to a left side channel in the loud array speaker 140 may output the audio signal for the plurality of channels rendered using the focused sound source rendering algorithm, and generate a focused sound source 720 on a left side of the user. Here, a wavefront 721 generated from the focused sound source 720 may be reflected off a wall because a position of the focused sound source 720 is adjacent to a left side wall of a listening space. The wavefront reflected on the wall may reproduce a virtual wave field 722 similar to the original wave field on the left side of the user 700.

A loud speaker corresponding to a rear channel in the loud array speaker 140 may output the audio signal for the plurality of channels rendered using the focused sound source rendering algorithm, and generate a focused sound source 730 in a rear of the user. Here, a wavefront 731 generated from the focused sound source 730 may be reflected off of the wall because a position of the focused sound source 730 is adjacent to a rear wall of the listening space. The wavefront reflected on the wall may reproduce the virtual wave field 730 in a form similar to the original wave field in the rear of the user 700.

In particular, the system for reproducing the wave field according to an embodiment of the present invention may reproduce a wave field using a sound bar without disposing an additional loud speaker at a side or at a rear, through forming a virtual wave field similar to the original wave field in a forward channel, using the wave field synthesis rendering algorithm, and disposing the virtual wave field in the listening space for a side channel and a rear channel, for the user to sense a stereophonic sound effect.

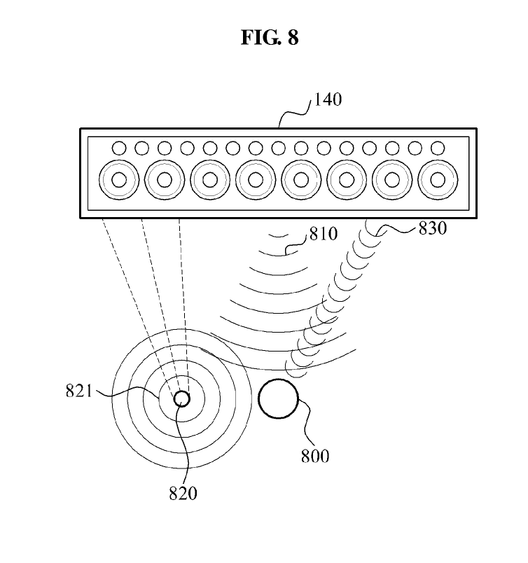

FIG. 8 is a diagram illustrating another example of a wave field reproduced by a system for reproducing a wave field according to an embodiment of the present invention.

In particular, FIG. 8 illustrates an example in which the system for reproducing the wave field reproduces a wave field when a wall is absent at a side and a rear of a listening space.

The renderer 120 of the system for reproducing the wave field may perform rendering on an audio signal for a plurality of forward channels, using a wave field synthesis rendering algorithm, and perform rendering on an audio signal for a plurality of side channels and rear channels, using a focused sound source rendering algorithm. Also, in a presence of a sound source having a directivity, the renderer 120 may perform rendering on an audio signal for a plurality of channels corresponding to a corresponding sound source, using a beam forming rendering algorithm.

The loud array speaker 140 may output the audio signal for the plurality of channels rendered by the renderer 120.

Here, a loud speaker corresponding to a forward channel in the loud array speaker 140 may output the audio signal for the plurality of channels rendered using the wave field synthesis rendering algorithm, and reproduce a virtual wave field 810 similar to an original wave field in front of a user 800.

Also, a loud speaker corresponding to a left side channel in the loud array speaker 140 may output the audio signal for the plurality of channels rendered using the focused sound source rendering algorithm, and generate a focused sound source 820 on a left side of the user. Here, a wavefront 821 generated from the focused sound source 820 may be delivered directly to the user and provide a stereophonic sound effect to the user because a position of the focused sound source 820 is adjacent to the left side of the user.

A loud speaker corresponding to a sound source having a directivity in the loud array speaker 140 may output an audio signal for a plurality of channels rendered using a beam forming rendering algorithm, and reproduce a sound 830 having a directivity in a listening space. Here, the sound 830 may be output to a user 900, and a direction in which the sound 830 is output may be detected by the user 900 as shown in FIG. 8. Also, the sound 830 may be output to and reflected off a wall or another location, and provide a surround sound effect in the listening space.

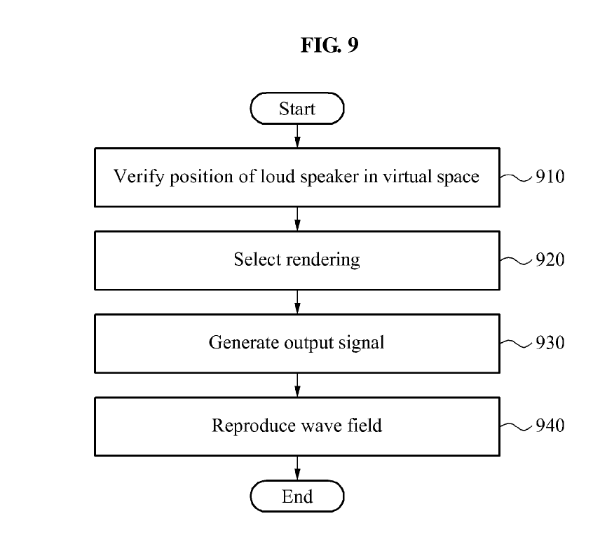

FIG. 9 is a diagram illustrating a method for reproducing a wave field according to an embodiment of the present invention.

In operation 910, the input signal processor 110 may divide an input signal into an audio signal for a plurality of channels, and identify a position of a loud speaker corresponding to the audio signal for the plurality of channels.

Here, the input signal may include at least one of an analog audio input signal, a digital audio input signal, and an encoded audio bitstream.

In operation 920, the renderer 120 may select a rendering algorithm to be applied to the audio signal for the plurality of channels, based on the position of the loud speaker identified in operation 910. Here, the renderer 120 may select rendering algorithms differing based on the plurality of channels because the position of the loud speaker varies based on the plurality of channels.

Here, the renderer 120 may receive an input of information selected by the user, and select a rendering algorithm for processing the audio signal for the plurality of channels.

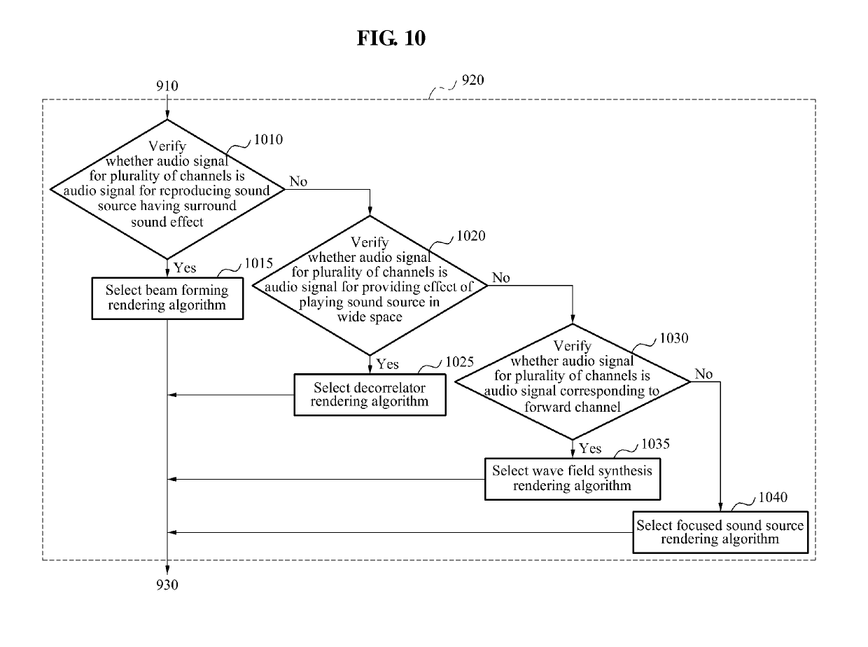

A process in which the renderer 120 selects a rendering algorithm will be discussed with reference to FIG. 10.

In operation 930, the renderer 120 may process the audio signal for the plurality of channels, using the rendering algorithm selected in operation 920, and generate an output signal.

The renderer 120 may process the audio signal for the plurality of channels and position data of the loud speaker corresponding to the plurality of channels, using a position at which a virtual sound source is generated determined using a microphone signal provided in a listening space and the selected rendering algorithm, and generate the output signal.

In operation 930, when a focused sound source rendering algorithm is selected, the renderer 120 may determine a position at which the focused sound source is generated, using the microphone signal provided in the listening space.

In operation 940, the loud speaker array 140 may output the output signal generated in operation 930, and reproduce a wave field. Here, the loud speaker array 140 may refer to a sound bar created by connecting a plurality of loud speakers into a single bar.

Also, the loud speaker array 140 may output the output signal obtained through amplifying the output signal generated in operation 930, and reproduce a wave field.

FIG. 10 is a flowchart illustrating a method for selecting rendering according to an embodiment of the present invention. Operations 1010 through 1040 of FIG. 10 may be included in operation 920 of FIG. 9.

In operation 1010, the rendering selection unit 510 may verify whether an audio signal for a plurality of channels is an audio signal for reproducing a sound source having a surround sound effect.

When the audio signal for the plurality of channels corresponds to the audio signal for reproducing the sound source having the surround sound effect, the rendering selection unit 510 may perform operation 1015. Here, when the audio signal for the plurality of channels refers to the audio signal for reproducing a sound source having a directivity, the rendering selection unit 510 may perform operation 1015.

Also, when the audio signal for the plurality of channels does not correspond to the audio signal for reproducing the sound source having the surround sound effect, the rendering selection unit 510 may perform operation 1020.

In operation 1015, the rendering selection unit 510 may select a beam forming rendering algorithm to be applied to the audio signal for the plurality of channels.

In operation 1020, the rendering selection unit 510 may verify whether the audio signal for the plurality of channels corresponds to an audio signal for providing an effect of playing a sound source in a wide space.

When the audio signal for the plurality of channels corresponds to the audio signal for providing the effect of playing the sound source in the wide space, the rendering selection unit 510 may perform operation 1025. Here, when the user inputs that a decorrelator rendering is to be applied to the audio signal for the plurality of channels, the rendering selection unit 510 may perform operation 510.

Also, when the audio signal for the plurality of channels does not correspond to the audio signal for providing the effect of playing the sound source in the wide space, the rendering selection unit 510 may perform operation 1030.

In operation 1025, the rendering selection unit 510 may select a decorrelator rendering algorithm to be applied to the audio signal for the plurality of channels.

In operation 1030, the rendering selection unit 510 may verify whether the audio signal for the plurality of channels corresponds to an audio signal corresponding to a forward channel.

When the audio signal for the plurality of channels is verified to be the audio signal corresponding to the forward channel, the rendering selection unit 510 may perform operation 1035. Here, where a position of the sound source is disposed at a rear of a speaker for outputting an audio signal, the rendering selection unit 510 may perform operation 1035.

When the audio signal for the plurality of channels does not correspond to the audio signal corresponding to the forward channel, the rendering selection unit 510 may perform operation 1040.

In operation 1035, the rendering selection unit 510 may select a wave field synthesis rendering algorithm to be applied to the audio signal for the plurality of channels.

In operation 1040, the rendering selection unit 510 may select a focused sound source rendering algorithm to be applied to the audio signal for the plurality of channels.

According to an embodiment of the present invention, it is possible to reproduce a wave field using a sound bar without disposing an additional loud speaker at a side or at a rear, through forming a virtual wave field similar to an original wave field in a forward channel, using a wave field rendering algorithm, and disposing a virtual sound source in a listening space for a side channel and a rear channel for a user to sense a stereophonic sound effect.

The above-described exemplary embodiments of the present invention may be recorded in computer-readable media including program instructions to implement various operations embodied by a computer. The media may also include, alone or in combination with the program instructions, data files, data structures, and the like. Examples of computer-readable media include magnetic media such as hard disks, floppy disks, and magnetic tape; optical media such as CD ROM discs and DVDs; magneto-optical media such as floptical discs; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described exemplary embodiments of the present invention, or vice versa.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. A system for reproducing a wave field, the system comprising:
an input signal analyzer to divide an input signal into an audio signal for a plurality of channels, and identify a position of a loud speaker corresponding to the plurality of channels;
a rendering unit to process the audio signal for the plurality of channels, using a rendering algorithm based on the position, and generate an output signal; and
a loud speaker array to output the output signal via the loud speaker corresponding to the plurality of channels, and reproduce a wave field.

2. The system of claim 1, wherein the rendering unit processes an audio signal for a plurality of channels corresponding to a forward channel, using a wave field synthesis rendering algorithm, and processes an audio signal for a plurality of channels corresponding to a side channel or a rear channel.

3. The system of claim 2, wherein the rendering unit determines a position at which a focused sound source is to be generated based on a listening space in which a wave field is reproduced when an audio signal for a plurality of channels is processed, using a focused sound source rendering algorithm.

4. The system of claim 1, wherein the rendering unit selects from among a focused sound source rendering algorithm, a beam-forming rendering algorithm, and a deccorelator rendering algorithm, based on a characteristic of a sound source, and processes an audio signal for a plurality of channels, using the selected algorithm.

5. An apparatus for reproducing a wave field, the apparatus comprising:
a rendering selection unit to select a rendering algorithm for a plurality of channels, based on at least one of information associated with a listening space in which a wave field is to be reproduced, a position of a channel, and a characteristic of a sound source; and
a rendering unit to render an audio signal of a channel, using the selected rendering algorithm.

6. The apparatus of claim 5, wherein the rendering unit to render the audio signal selects a wave field synthesis rendering algorithm when the channel is a forward channel disposed in front of a user, or a position of a sound source is disposed at a rear of a speaker for outputting the audio signal.

7. The apparatus of claim 5, wherein the rendering selection unit selects a focused sound source rendering algorithm when the channel is a side channel disposed at a side of a user, and a rear channel disposed behind the user.

8. The apparatus of claim 7, wherein the rendering unit to render the audio signal performs rendering on audio signals output from a speaker to be gathered at a predetermined position simultaneously, and generates a focused sound source at the predetermined position.

9. The apparatus of claim 7, wherein the rendering unit to render the audio signal renders the audio signal to generate a focused sound source at a position adjacent to a wall when a wall is present at a side and a rear of a listening space in which a wave field is to be reproduced.

10. The apparatus of claim 7, wherein the rendering unit to render the audio signal renders the audio signal to generate a focused sound source at a position adjacent to a user when a wall is absent at a side and a rear of a listening space in which a wave field is to be reproduced.

11. The apparatus of claim 5, wherein the rendering selection unit selects a beam-forming rendering algorithm when a sound source has a directivity, or a surround sound effect.

12. The apparatus of claim 5, wherein the rendering selection unit selects a decorrelator rendering algorithm in a presence of an effect of a sound source to be reproduced in a wide space.

13. A method for reproducing a wave field, the method comprising:
dividing an input signal into an audio signal for a plurality of channels, and identifying a position of a loud speaker corresponding to the plurality of channels;
processing the audio signal for the plurality of channels, using a rendering algorithm based on the position, and generating an output signal; and
outputting the output signal, using the loud speaker corresponding to the plurality of channels, and reproducing a wave field.

14. The method of claim 13, wherein the generating of the output signal comprises:
processing an audio signal for a plurality of channels corresponding to a forward channel, using a wave field synthesis rendering, and processing an audio signal for a plurality of audio signals corresponding to a side channel or a rear channel, using a focused sound source rendering algorithm.

15. The method of claim 14, wherein the generating of the output signal comprises:
determining a position for generating a focused sound source, based on a listening space in which a wave field is reproduced when the audio signal for the plurality of channels is processed, using the focused sound source rendering algorithm.

16. A method for reproducing a wave field, the method comprising:
selecting a rendering algorithm for a plurality of channels, based on at least one of information associated with a listening space in which a wave field is reproduced, a position of a channel, and a characteristic of a sound source; and
rendering an audio signal of a channel, using the selected rendering algorithm.

17. The method of claim 16, wherein the selecting of the rendering algorithm comprises:
selecting a wave field synthesis rendering when the channel is a forward channel disposed in front of a user, or a position of a sound source is disposed at a rear of a speaker for outputting the audio signal.

18. The method of claim 16, wherein the selecting of the rendering algorithm comprises:
selecting a focused sound source rendering algorithm when the channel is a side channel disposed at a side of a user and a rear channel disposed behind the user.

19. The method of claim 18, wherein the selecting of the rendering algorithm comprises:
rendering the audio signal to generate a focused sound source at a position adjacent to a wall when a wall is present at a side and a rear of a listening space for reproducing a wave field.

20. The method of claim 18, wherein the selecting of the rendering algorithm comprises:
rendering the audio signal to generate a focused sound source at a position adjacent to a wall when a wall is absent at a side and a rear of a listening space in which a wave field is reproduced.
